(19) United States
(12) Patent Application Publication
(10) Pub. No.: US 2005/0138914 A1
(43) Pub. Date: Jun. 30, 2005

(54) Turbo rocket with real carnot cycle

(76) Inventor: Marius Paul, Fullerton, CA (US)

Correspondence Address: RICHARD ESTY PETERSON;Patent Attorney, 1905-D PALMETTO AVENUE, PACIFICA, CA, 94044, US

(21) Appl. No.: 10/833,382

(22) Filed: Apr. 28, 2004

Related U.S. Application Data
(60) Provisional application No. 60/466,270, filed on Apr. 28, 2003.
(60) Provisional application No. 60/470,706, filed on May 15, 2003.
(60) Provisional application No. 60/486,637, filed on Jul. 11, 2003.
(60) Provisional application No. 60/507,400, filed on Jan. 23, 2004.

(51) Int. Cl. F02K 3/02

(52) U.S. Cl. 60/226.1; 60/246

(57) ABSTRACT

Engine embodiments primarily designed for aircraft propulsion and power generation incorporating the Carnot cycle for efficient combustion with typical embodiments including air compressors having one or more stages with isothermal compression and including combustion and expansion chambers having in part isothermal expansion before final adiabatic expansion.

### REFERENCES TO PRIOR APPLICATIONS

This application relies on the priority of the following provisional applications:

U.S. Provisional Application Ser. No. 60/466,270, filed Apr. 28, 2003, entitled, “Turbo Rocket with Real Carnot Cycle;”

U.S. Provisional Application Ser. No. 60/470,706, filed May 15, 2003, entitled, “Turbo Rocket with Real Carnot Cycle and Transpiration Blades;”

U.S. Provisional Application Ser. No. 60/486,637, filed Jul. 11, 2003, entitled, “Turbo Rocket with Real Carnot Cycle Continued;”

U.S. Provisional Application Ser. No. 60/507,400, filed Sep. 30, 2003, entitled, “Turbo Rocket with Real Carnot Cycle Continued Second.”

### BACKGROUND OF THE INVENTION

This invention relates primarily to a combined turbine and rocket engine that implements the Carnot cycle. The combined turbine and rocket engine, also termed a turbine-rocket or turbo rocket, is designed to provide a highly fuel-efficient propulsion system for high altitude flight where available oxygen diminishes to levels where rocket propulsion with supplemental oxygen is required. To accommodate different levels of oxygen availability from atmospheric, where oxygen is freely available, to space, where oxygen is absent, new engine designs are required.

The Carnot cycle has been considered an ideal thermodynamic cycle maximum theoretical efficiency. However, the real Carnot cycle has not heretofore been implemental in a physical embodiment that effectively follows the four phases of the cycle. As indicated in the cycle diagrams included in this specification, the real thermodynic Carnot cycle includes the following four basic phases in a T-S (temperature-enthalpy) diagram:
1-2 isothermal compression;
2-3 polytropic (adiabatic) compression;
3-4 isothermal-stoichiometric combustion-expansion;
4-1.a polytropic (adiabatic) final expansion.

The rocket engines of this invention incorporate the Carnot cycle and are represented in several different embodiments. Many of the component elements of the specific embodiments of the turbo rocket engine are derived from prior turbine engine designs and turbojet engine designs of this inventor.

### SUMMARY OF THE INVENTION

The turbo rocket engine of this invention is designed to incorporate the real Carnot cycle into physical embodiments, primarily for high altitude propulsion. In addition, the embodiments of the turbo rocket engine define propulsion systems for aircraft that are operable in atmospheric and stratospheric conditions at maximum efficiency. Certain embodiments of the engines omit the turbine component and other embodiments are adapted for power generation. The engine cycle is by definition a universal Carnot cycle that is advantageous for air and near space propulsion.

High efficiencies are achieved by use of a ram air intake to enhance compression and drive associated air turbines that operate a counter rotating axial compressor for ultra high compression of combustion air. Where altitudes cause a diminishing supply of air, the process is supplemented by liquid oxygen supplied in progressive proportions.

### BRIEF DESCRIPTION OF THE DRAWINGS

FIG. 1 is a cycle diagram, illustrating a Carnot cycle for certain turbo rocket engines of this invention.

FIG. 2 is a schematic illustration of a first embodiment of the turbo rocket engine.

FIG. 3 is a schematic illustration of the engine of FIG. 2, showing gas flow streams.

FIG. 4 is an enlarged schematic illustration of a part of the engine of FIG. 3.

FIG. 5 is a schematic illustration of a second embodiment of the turbo rocket engine.

FIG. 6 is a schematic illustration of a third embodiment of the turbo rocket engine.

FIG. 6A is a cycle diagram, illustrating a Carnot cycle for the turbo rocket engine of FIG. 6

FIG. 7 is a schematic illustration of a fourth embodiment of the turbo rocket engine.

FIG. 7A is a cycle diagram, illustrating a Carnot cycle for the turbo rocket engine of FIG. 7.

FIG. 8 is a perspective view, partially in cross section, of a turbine blade with internal cooling.

FIG. 9 is a perspective view, partially in cross section, of the turbine blade of FIG. 8 in a turbine rotor.

FIG. 10 is a cross sectional view of the turbine blade of FIG. 8 and an adjacent stator blade.

FIG. 11 is a schematic illustration of a fifth embodiment of the turbo rocket engine.

FIG. 11A is a cycle diagram, illustrating the Carnot cycle for the turbo rocket engine of FIG. 11.

FIG. 12 is a schematic illustration of a sixth embodiment of the turbo rocket engine.

FIG. 13 is a cycle diagram, illustrating the Carnot cycle for the turbo rocket engine of FIG. 12.

FIG. 14A is a schematic illustration of the side of a ram-air rocket engine.

FIG. 14B is a schematic illustration of the top of the engine of FIG. 14

FIG. 14C is a cycle diagram, illustrating the Carnot cycle for the engine of FIGS. 14A and 14B.

FIG. 15 is a schematic illustration of a cryogenic rocket engine.

FIG. 16 is a schematic illustration of a seventh embodiment of the turbo rocket engine.

FIG. 17 is a schematic illustration of an enlarged portion of the engine of FIG. 16.

FIG. 18 is a cycle diagram, illustrating the Carnot cycle for the engine of FIG. 16.

### DETAILED DESCRIPTION OF THE PREFERRED EMBODIMENTS

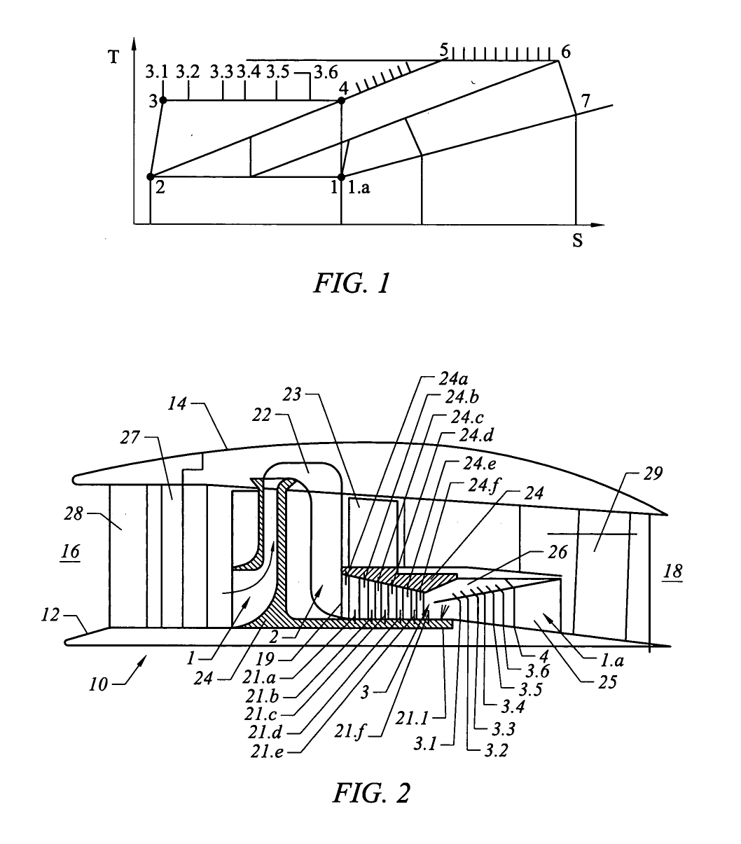

Referring to FIGS. 1 and 2, the turbo rocket engine shown schematically in FIG. 2, and identified generally by the reference numeral 10, follows the real Carnot cycle diagrammatically depicted in FIG. 1. In the T-S diagram of FIG. 1, the first embodiment 20 of the turbo rocket engine 10 undergoes isothermic compression from points 1 to 2, polytropic (adiabatic) compression from points 2 to 3, and a staged progressive isothermal stoichiometric combustion and expansion from 3.1 to 3.2 to 3.3 to 3.4 to 3.5 to 3.6 to 4. With a final polytropic (adiabatic) expansion to 1.a, the cycle is essentially complete.

In the turbo rocket engine 10 of the figures, there is typically a central core 12 with an outer housing 14 with an intake opening 16 and a discharge orifice 18, with a complex of passages from intake opening 16 to the discharge orifice 18 that generates the unique cycle of operation.

In the engine embodiment 20 of FIG. 2, there is included a centrifugal, heat exchanging air-turbine rotor 21 that initially compresses air that is then delivered through heat exchanging struts 22 to a staged axial compressor 19. Outwardly directed, axial compressor blades 21.a-21.f on an extended air turbine rotor hub 21.1 are driven in a counter rotating direction from a complimentary set of inwardly directed compressor blades 24.a-24.f on the core 24 of an axial air turbine 23 with outer fan-like blades 23.1.

Centrifugal compression of air in the hollow core 21.2 of the air turbine blades 21.3 is cooled by the cold by-pass air around the blades which usually has a 5-20 by-pass ratio over air funneled through the air-turbine rotor 21 and hollow struts 22, which function as an intercooler between the centrifugal and axial compressors to further cool the centrifugally compressed air. The intensive cooling of the centrifugally compressed air results in an isothermal compression indicated in FIG. 1 by the cycle phase 1-2.

The staged axial compressor 19 is provided with alternating counter rotating, outwardly directed blades 21.a-21.f, and inwardly directed blades 24.a-24.f to produce a polytropic (adiabatic) compression indicated in FIG. 1 by phase 2-3 of the cycle.

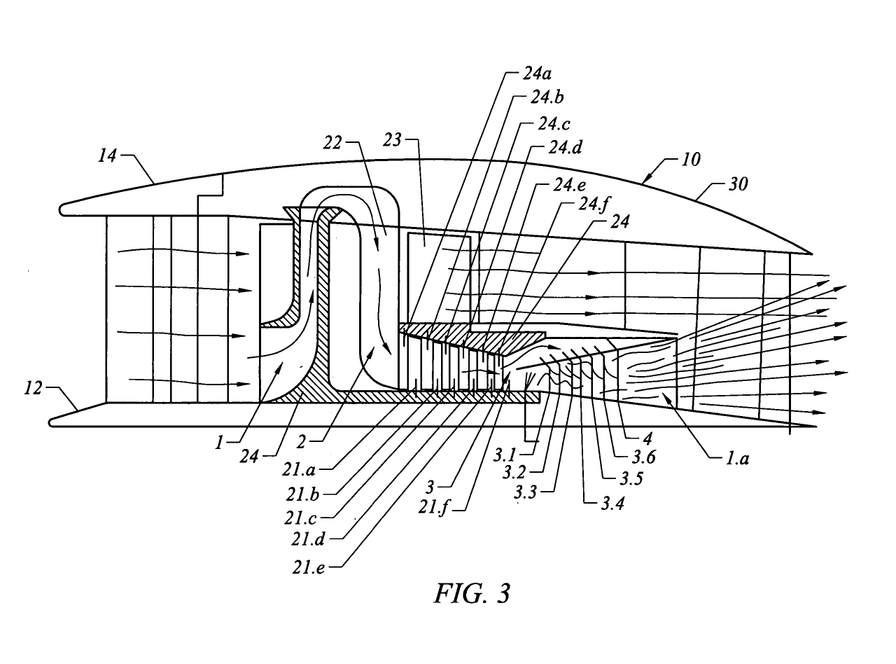

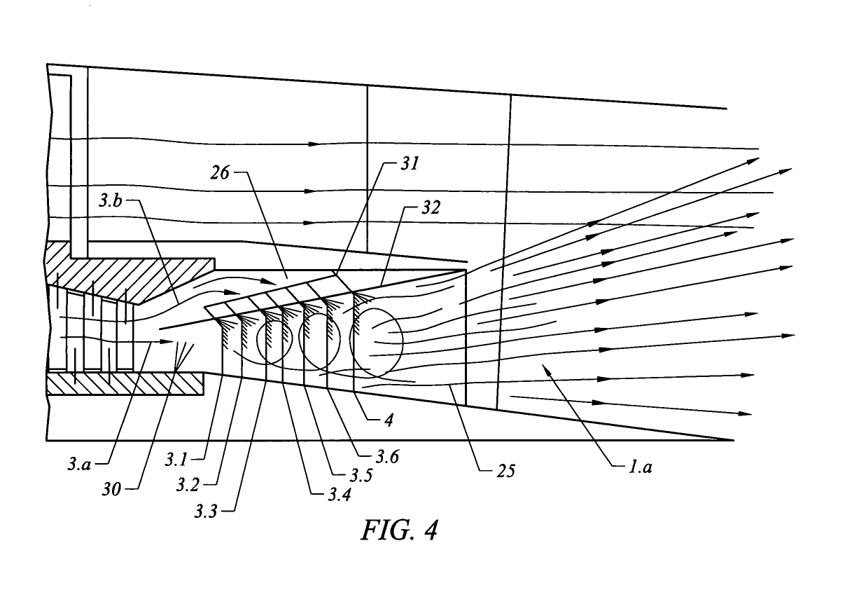

Isothermic-stoichiometric combustion and expansion represented by phase 3-4 in FIG. 1 for the embodiment 20 of FIG. 2 is shown with air and gas flows in the schematic illustration of FIGS. 3 and 4.

The majority of the intake air flows through the engine 10, by-passing the compressor apparatus except to drive the hollow blades 21.3 of the air turbine rotor in one direction and the fan blades 23.1 of the fan turbine 23 in the opposite direction.

Air that is highly compressed in the centrifugal and axial compressors from the phase 1-2 and 2-3 points, is divided into two flows 3.a and 3.b as shown in the enlarged schematic of FIG. 4. An air injection chamber 26 and primary combustion chamber 25 are divided by a conical expansion nozzle 32 provided with a series of peripheral windows 3.1-3.6 and 4. A complimentary series of injector nozzles 31 injects fuel into the compressed air streaming through the nozzle windows 3.1-3.6 to mix and expand with the axial central compressed air flow 3.1 that picks up fuel from central slinger injectors 30 when entering the combustion chamber 25 at phase point 4. The final polytropic (adiabatic) expansion in the phase from 4-1.a closes the real Carnot cycle for the internal systems of the turbo rocket engine 10.

The variable volume intake control 27 regulates the high volume of the by-pass air flow 28-29 and the compressor air flow, and regulates the angularity of the prewhirl air at the entrance to the engine 10. The ram compressed, by-pass air mixes with the combustion gases for a final heated expansion through the discharge orifice 18.

The combustion process can be stoichiometric, since the products of combustion do not drive a turbine for compression but expand in a combustion-staged nozzle, producing a maximum power density.

For high altitude flight, ram air can be supplemented by liquid oxygen injected by one or more nozzles, similar to the fuel injection nozzles 30 and 31. Oxygen is added to the air stream in progressive proportions as available high altitude air diminishes.

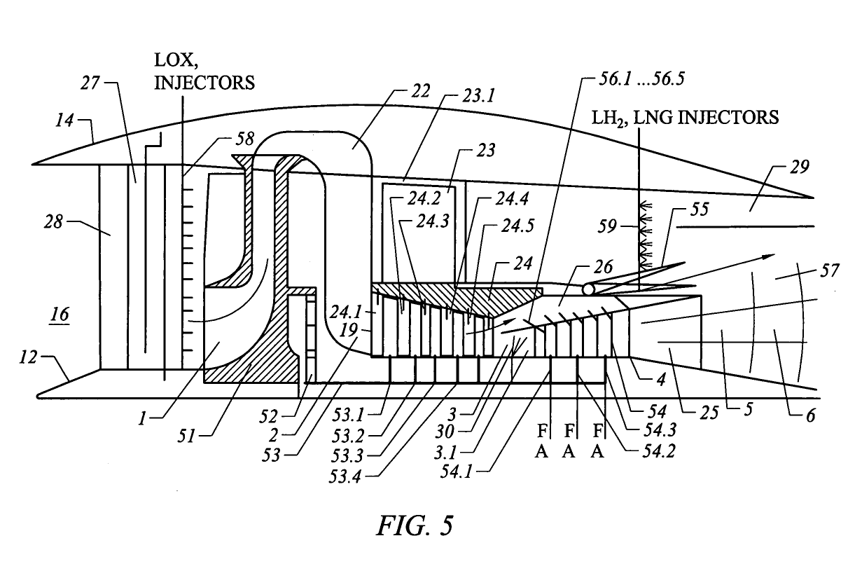

In FIG. 5, a second embodiment 50 of the turbo rocket engine is shown. The turbo rocket engine embodiment 50 has a variable multi-stage Carnot cycle with components similar to those of FIGS. 2-4. In addition, a modified isothermal centrifugal compressor 51 receives ram air at phase point 1, and delivers compressed air through the inter-cooling struts 22 at the temperature and pressure of phase point 2, before compression in the axial compressor 19. The hollow bladed centrifugal compressor 50 rotates in an opposite direction to the free wheeling air turbine 23, with its outwardly directed fan-like blades 23.1 and its inwardly directed compressor blades 24.1 to 24.6.

In the engine embodiment 50 of FIG. 5, the modified isothermal centrifugal compressor 51 includes a planetary gear assembly 52, connecting the centrifugal compressor 51 to a turbo-compressor shaft with outwardly directed axial compressor blades 53.1-53.5, which co-act with counter-rotating, inwardly directed axial compressor blades 24.1-24.6 of the associated air turbine 23. Additionally, the turbo-compressor shaft has gas turbine blades 54.1-54.3, which are supplied compressed air at the pressure and temperature at phase point 3, and fuel from injector 30 for expansion of combusted gases from the combustor 3.1 through a gas turbine 54 with staged additions of compressed air from chamber 26 and injectors 56.1-56.5. The staged air and fuel supply produces an isothermal, stochiometric combustion and expansion typical of the Carnot cycle until cycle phase point 4.

The final adiabatic expansion 4-5 closes the total real Carnot cycle. In parallel with the internal Carnot cycle, the ram compressed by-pass air proportionately provides greater thrust and is enhanced at higher elevations by liquid oxygen injectors 58 at the intake 16, and liquid hydrogen or liquid natural gas injectors 59 at the final mixing nozzle 57 before the discharge orifice 18, extending a combined cycle phase from 4-5-6 with a final adiabatic pressure-temperature expansion from phase points 6-7.

At very high speed, the energy of the ram air drives the centrifugal compressor 51 and counter-rotating air turbine 23, and the power required for the gas turbine 54 diminishes. To prevent over rotation, the peripheral combustion chamber 26 has a variable opening valve 55, which regulates flow through the gas turbine 54 by diverting the gas flow directly into the by-pass flow 29 for mixing and discharge through the discharge orifice 18.

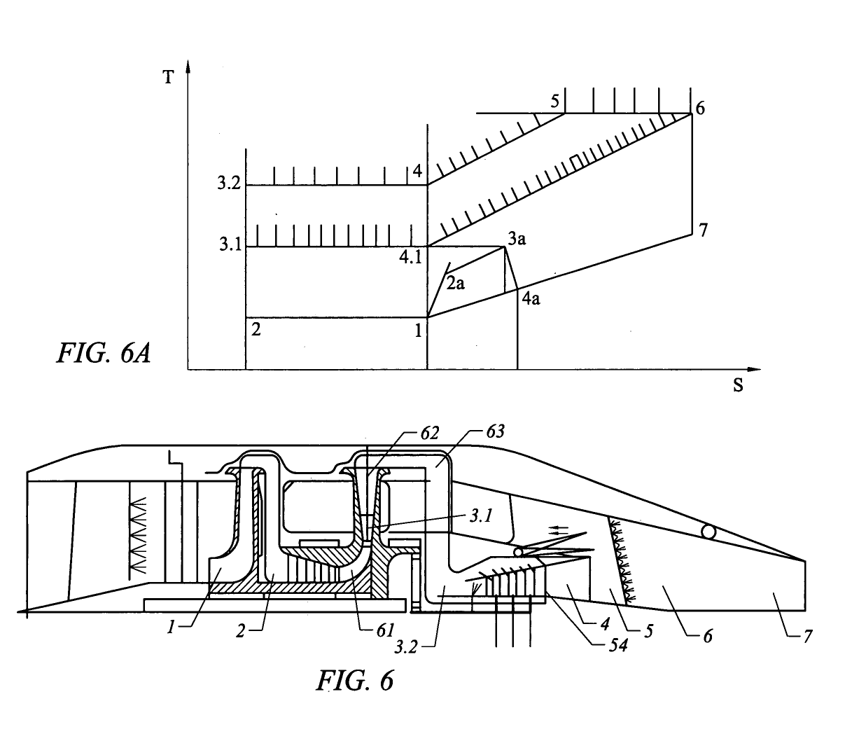

Referring to FIG. 6, the turbo rocket engine 10 has an embodiment 60 with a front end and back end that are the same as the embodiment 50 of FIG. 5. In a middle section, the free wheeling air turbine 19 is replaced by first centrifugal compressor 61 and a second counter rotating centrifugal compressor 62 radially staged from the first centrifugal compressor 61. Final heat exchanging struts 63 provide an intercooling before entry of the compressed air into the combustion chambers and gas turbine 54.

Using the multiple compressor stages, including the axial compressor 19 with counter rotating blades driven by centrifugal compressors 51 and 62, pressure ratios over 100 can be created and the efficiencies of the modified Carnot cycle maximized as shown in FIG. 6A. The equivalent maximum temperature for the Brayton cycle 1-2a-3a-4a-1-3a at the temperature 3.1, generates insignificant power when compared to the Carnot cycle 1-2-3.1-4.1-1, with the addition of liquid oxygen is extended to 4.1-6 and final expansion 6-7-1.

At high speed, the ram air will raise the pressure ratios for precombustion at 3.2, followed by isothermal combustion 3.2-4, constant pressure combustion 4-5 and maximum stoichiometric combustion 5-6 and final expansion 6-7.

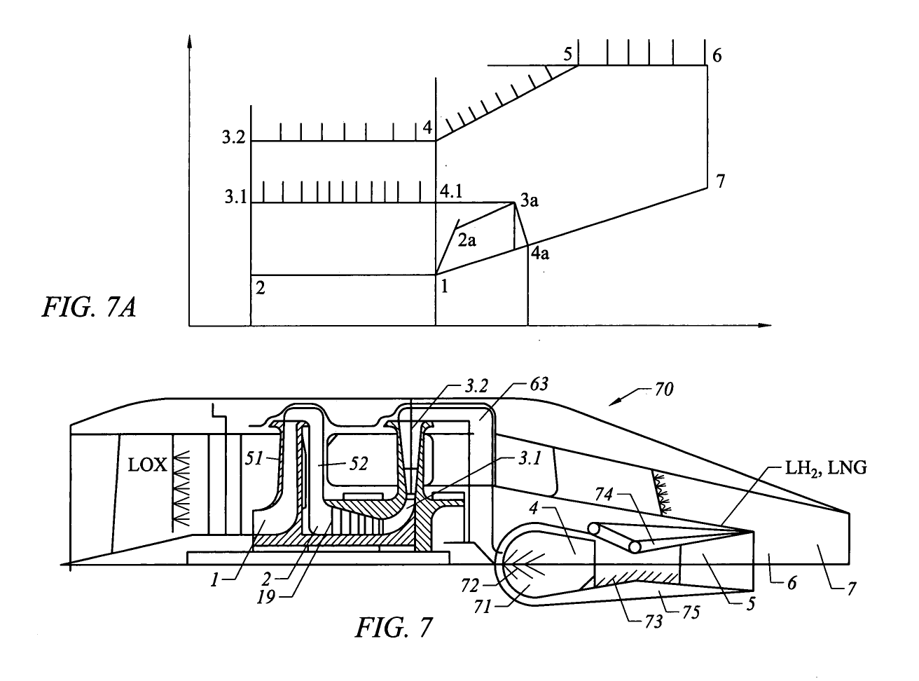

Referring to FIGS. 7 and 7A, a further embodiment 70 of the turbo rocket engine 10 is shown, with its extended Carnot cycle diagram. In FIG. 7, the engine embodiment 70 has a front end and mid section similar to the embodiment 60 of FIG. 6. The engine embodiment 70 includes the internal isothermal centrifugal compressor 51 and intercooler 22, the axial compressor 19 and the radially staged first and second centrifugal compressors 61 and 62 with the final intercooler struts 63.

The high pressure compressed air is supplied to a combustion chamber 71 with central fuel injectors 72 and staged fuel and air injectors 73 along the venturi section 75 with a variable geometry nozzle control 74 to regulate expansion. The liquid oxygen injectors 58 and liquid hydrogen or liquid natural gas injectors 59 provide supplemental oxygen as needed and added thrust for the final expansion in the mixing nozzle 57 before ejection from the discharge orifice 18.

Again, with the additional three stages of combustion, the Carnot cycle is extended from 3.2-4-5-6-7 for maximized power and efficiency.

Although embodiments of the turbo rocket engine that omit a gas turbine can easily operate at the stoichiometric level of fuel combustion, those embodiments including a gas turbine operate most efficiently with cooling of the rotor and stator blades to achieve stoichiometric levels.

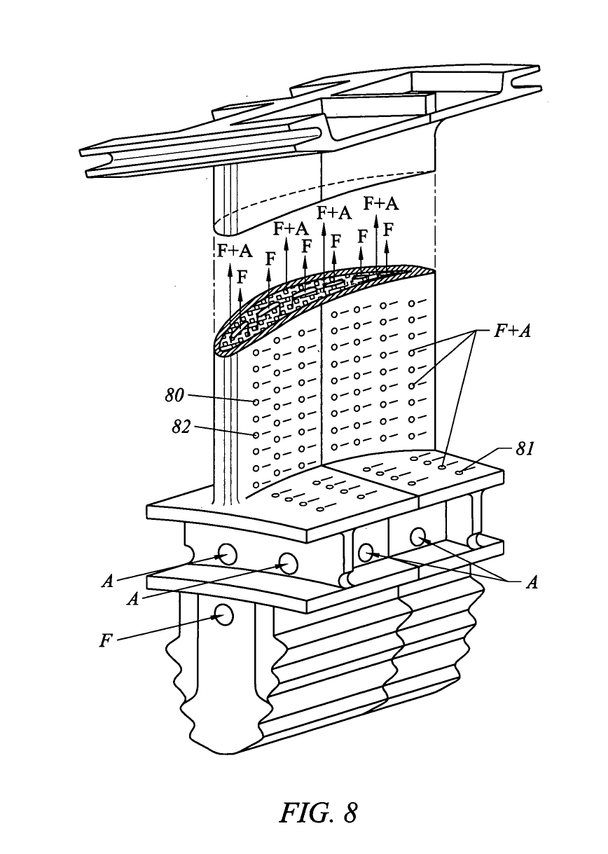

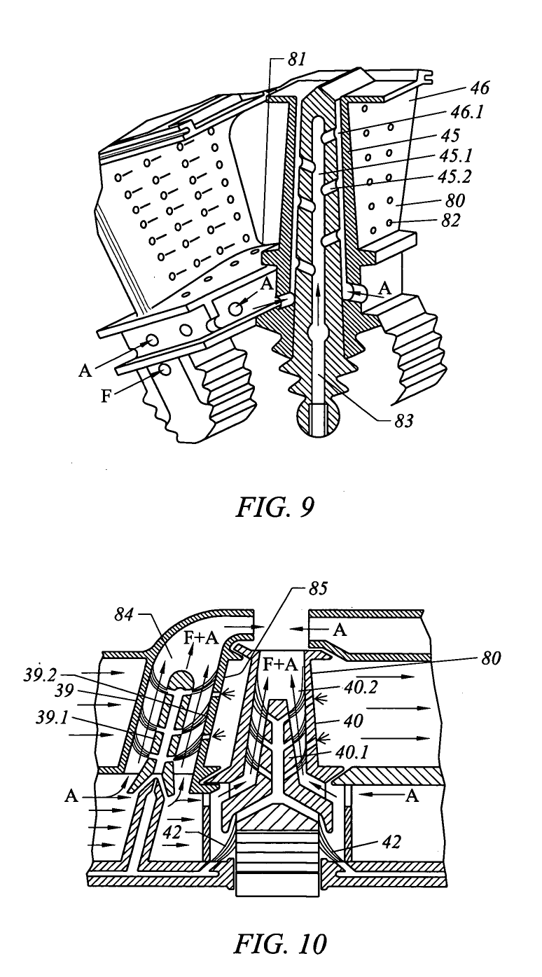

Referring the FIGS. 8 to 10, a design for internal and external cooling of the blades of the gas turbine 54 of FIGS. 5 and 6 are shown. The concepts are similar to those described in my U.S. Pat. No. 5,177,954, but modified by including bleed holes 81 and 82 that communicate with the hollow core 83 of the modified rotor blade 80 of FIG. 8 and core 84 of the stator blade 85, shown in FIG. 10. As illustrated, fuel and air are forced into the rotor blade 80 and stator blade 85 and out the bleed holes to coat the blades and contribute to the combusted gas flow while cooling the blades.

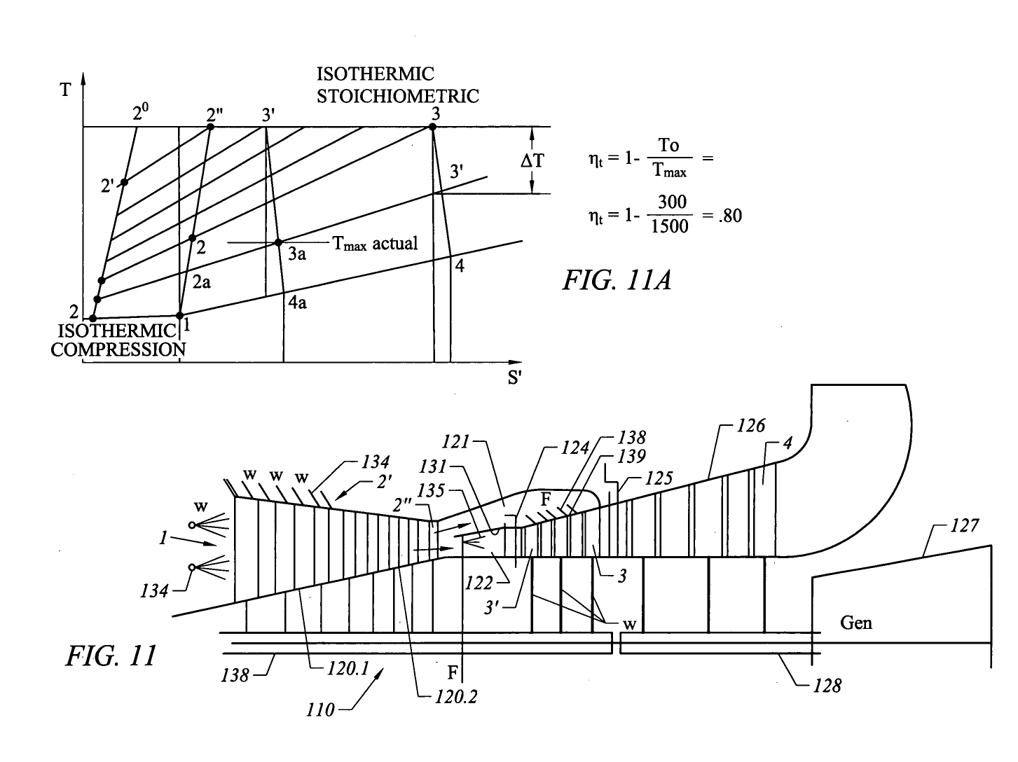

Referring to FIGS. 11 and 11A, a multi-stage isothermal stoichiometric gas turbine engine 110 is illustrated, which incorporates three phases of the Carnot cycle. The cycle phases include adiabatic, polytropic compression 1-2′; isothermal, stoichiometric combustion and expansion 2′-3, polytropic adiabatic expansion 3-4, and a rejection of residual heat 4-1, which closes the cycle as depicted in FIG. 11A.

In the gas turbine engine 110 of FIG. 11, an axial compressor 120 has an isothermal compression stage 120.1 using a spray of water through injectors 134 to maintain a constant temperature and an adiabatic compression stage 120.2 for final compression to phase point 2″. The compressed air is supplied to peripheral chamber 121 surrounding central annular combustion chamber 122. A staged supply of fuel through injectors 135 and 138 is in part carried through windows 139 into the isothermal gas turbine 123 of the type described with reference to FIG. 5. The isothermal gas turbine 123 is provided with variable geometry gas turbine nozzles 124 and 125 to control the volume and maintain the pressure of motive gases delivered to the multi-stage axial power turbine 126 at variable demand levels. The power turbine 126 drives the power generator 127 by shaft 128 with spent motive gases released through pipe 130. The isothermal gas turbine 123 drives the multi-stage compressor 120 by the shaft 138 and is operated at stoichiometric levels by spraying the conical wall 131 of the combustion chamber 122 with fuel by injectors 135 and by the staged spray of fuel through the windows 139 by injectors 138 in the peripheral chamber 121.

Additional cooling is provided by water or fuel injection into and through the blades of the turbines as described with reference to FIGS. 8-10.

The double process of evaporative cooling of the combustion chamber walls and the air and super fine spray of vaporizing fuel into the multiple stages of the gas turbine 123 permits a complete process of combustion at stoichiometric levels. The controlled maintenance of the maximum pressure at part loads maintains the cycle efficiency and the lowered pressure and consequently lower efficiency at part loads, typical of the Brayton cycle.

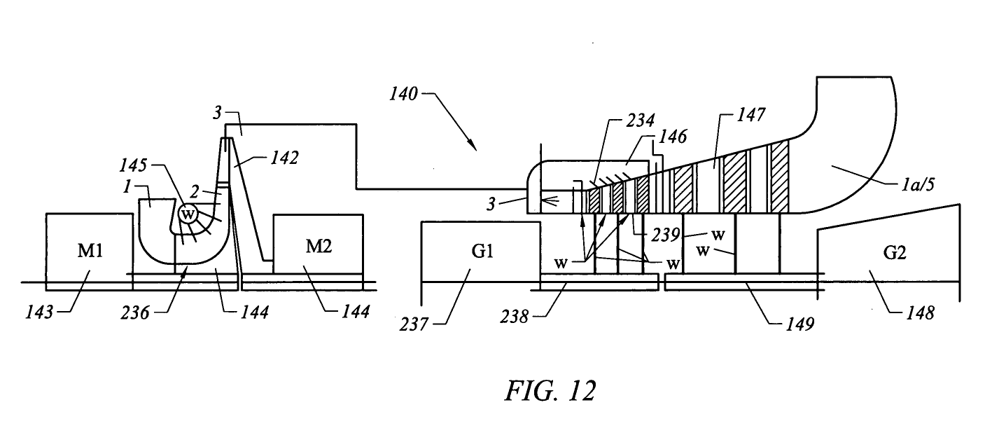

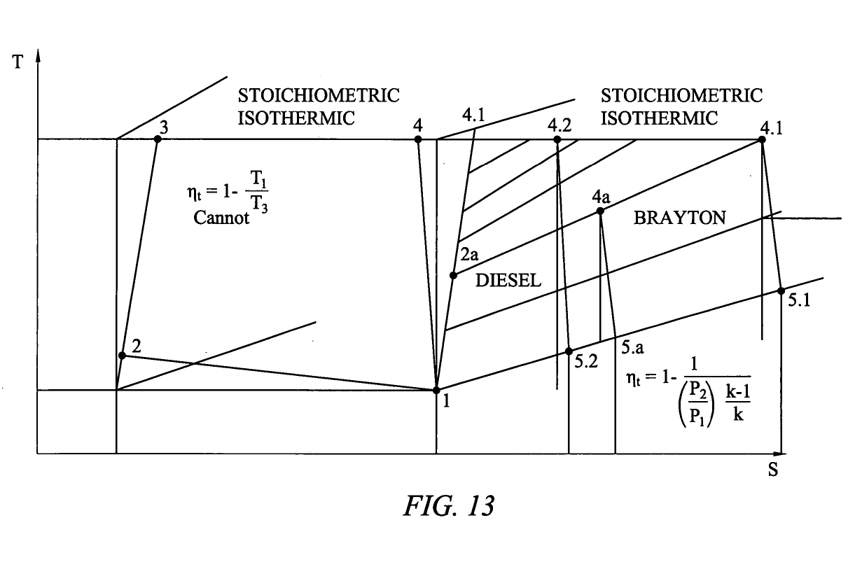

Referring to FIG. 12 and to the T-S diagram of FIG. 13, a universal thermodynamic gas turbine 140 is depicted. The universal gas turbine 140 is comprised of three main functional assemblies.

The first assembly includes a centrifugal two-stage compressor 236 with a first isothermal stage central rotor 141 surrounded by a second adiabatic stage, counter rotating peripheral rotor 142 driven by the electric motors 143 and 144, respectively.

A series of water injectors 145 spray cooling water into the central compressor rotor 141 proportional to the compression level to generate a polytropic-isothermic effect for cooling the first stage compression. This phase is indicated on the T-S diagram of FIG. 13 by the evolution from phase point 1 to 2. The second stage compression by the counter rotating peripheral rotor 142 produces a polytropic adiabatic compression indicated by phase points 2-3 in the cycle diagram of FIG. 13.

A second assembly is formed by a gas turbine 146 with isothermal combustion. The gas turbine 146 drives the electric generator 237 by shaft 238. The gas turbine 146 is similar in construction to the gas turbines in FIGS. 5 and 11, and evolves the cycle from phase points 3-4.1 and 4.1-4.2.

The third assembly is formed by an axial, polytropic, adiabatic power turbine 147 which drives the electric generator 148 by the shaft 149. Controlled injection of water into the turbine blades 234 and stators 239 allows the gas turbines 146 and 147 to maintain temperatures that are consistent with the temperature limits of the materials of the turbines.

The exhaust of the gases and final expansion completes the cycle from phase points 4.2-5 and 5-1, closing the cycle.

The universal thermodynamic gas turbine cycle, as depicted in FIG. 13, includes a Carnot cycle 1-2-3-4.1-1 for the highest pressure and highest temperature at part loads, thereby maximizing the thermodynamic efficiency.

Also, at full load including the isothermal-stoichiometric phases of the cycle 1-4.1, 4.2-5.1-1, a maximum power can be generated. For comparison, the Brayton cycle 1.a-2a-4.2-5.1-1 and diesel cycle 1a-2.a-4.a-5.a-1a are included in the diagram of FIG. 13.

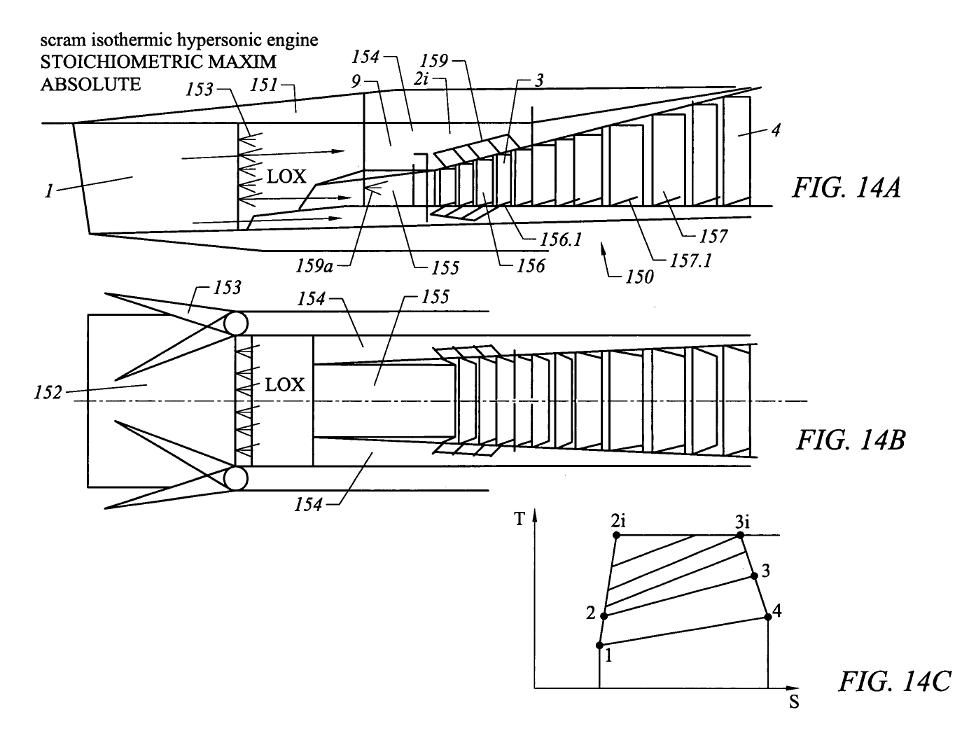

Referring to FIGS. 14A and 14B, a ram-jet rocket engine, designated by the reference numeral 150, is shown. The engine 150 is designed for high speed, supersonic operation in atmospheric, stratospheric and space conditions and is operable with, or preferably independent of, a turbo component. For example, the engine may be incorporated into an aircraft that is launched from a ground accelerator or from an airborne carrier where sufficient speed is attained to sustain an ignition and independent acceleration on fuel combustion. Alternately, the engine 150 may be included on an aircraft having a conventional engine or an engine 10 as described herein for lower speed atmospheric operation and independent operation at stratospheric and space operation.

The ram-jet rocket engine 150 has an outer body 151 having a variable geometry intake port 152 regulated by an intake control valve 153. A central primary combustion chamber 155 is followed by an expanding multi-stage isothermal combustion chamber 156 of the type described with reference to FIGS. 5, 11 and 12. The expanding isothermal combustion chamber 156 is followed by an adiabatic, multi-stage combustion and expansion nozzle 157. A peripheral air plenum 154 supplies compressed ram air that is supplemented or replaced by oxygen from liquid oxygen nozzles 158 as available air diminishes at high altitudes and space flight. Fuel is injected through fuel injector nozzles 159 in the primary combustion chamber 155 and along the windows 156.1 of the multi-stage, isothermal combustion chamber 156 to maintain isothermal conditions. The additional air and/or oxygen entering the windows 157.1 of the multi-stage combustion and expansion nozzle 157 cools the surface of the expanding nozzle structure. The injected fuel and injected liquid oxygen has a combined cooling effect over the internal and external surfaces of the multi-stage isothermal combustion chamber 156 and the multi-stage adiabatic combustion and expansion nozzle 157. The staged fuel vaporization and super mixing provides for perfect stoichiometric combustion and high core temperatures to the ejecting gas stream.

The configured engine 150 of FIGS. 14A and 14B operates as a ram-jet and scram-jet for super high speed where air is available, and as a hybrid scram-jet rocket as air is supplemented by liquid oxygen. In space, where oxygen is lacking, the variable geometry intake valve 153 is closed and the engine 150 operates as a pure rocket with the full capacity of the oxygen injectors 158.

As illustrated in FIG. 14C, the cycle proceed from the stage points in FIG. 14A from stages 1-2-3-4.-1. At progressively higher speeds where the compression pressure increases by ram air, the cycle improves its efficiency and follows the stage points in FIG. 14C from 1-2i-3i-4-1.

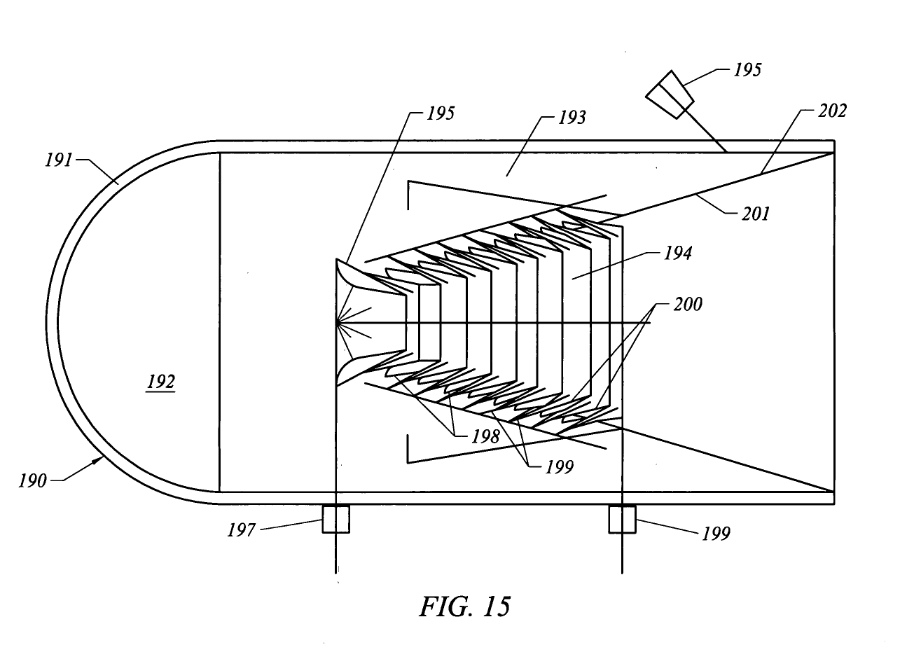

Referring to FIG. 15, a staged rocket engine 190 is shown. The staged rocket engine 190 has a housing 191 with a cryogenic oxygen compartment 192 that forms a plenum 193 around the core nozzle 194. Liquid oxygen is injected into the plenum 193 through one or more injectors 195 and forms a cryogenic gaseous oxygen. The core nozzle 194 is equipped with a lead venturi nozzle 195 and fuel injector 197.

A series of multiple conical venturi nozzles 198 of increasing size with accompanying staged fuel injectors 199 form an injection cascade of fuel and cryogenic oxygen through the nested windows 200. The isothermal combustion and expansion continues to the final ejection nozzle 201 where the adiabatic expansion within the cooled walls 202 provides final propulsion in a nozzle structure that is sufficiently cooled to allow for stoichiometric combustion. In this manner, by definition, the motive gas flow has a maximum density providing a super powerful reactive mass flow for propulsion.

The successive addition of new heat energy to the central adiabatic flow produces an isothermal Carnot cycle stage to maintain the outer nozzle structure within thermal limits until the final adiabatic expansion in the discharge nozzle 201.

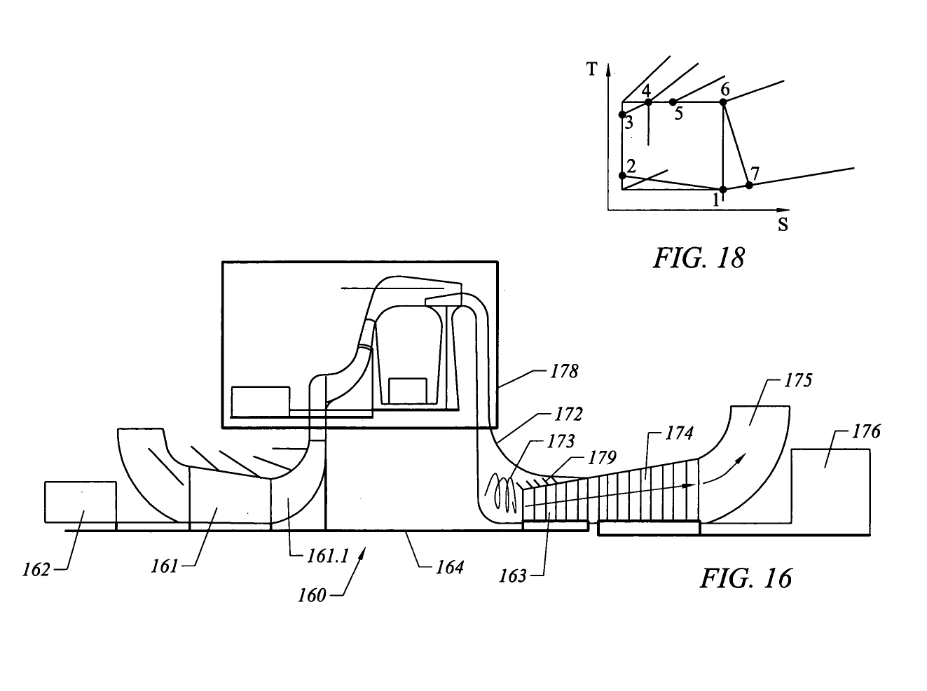

Referring to FIG. 16, an embodiment 160 turbo generator engine 10 operating under a real Carnot cycle with a supplemental super pressure cycle is shown. The engine embodiment 160 is suitable for power generation where high efficiencies and low fuel consumption is desired.

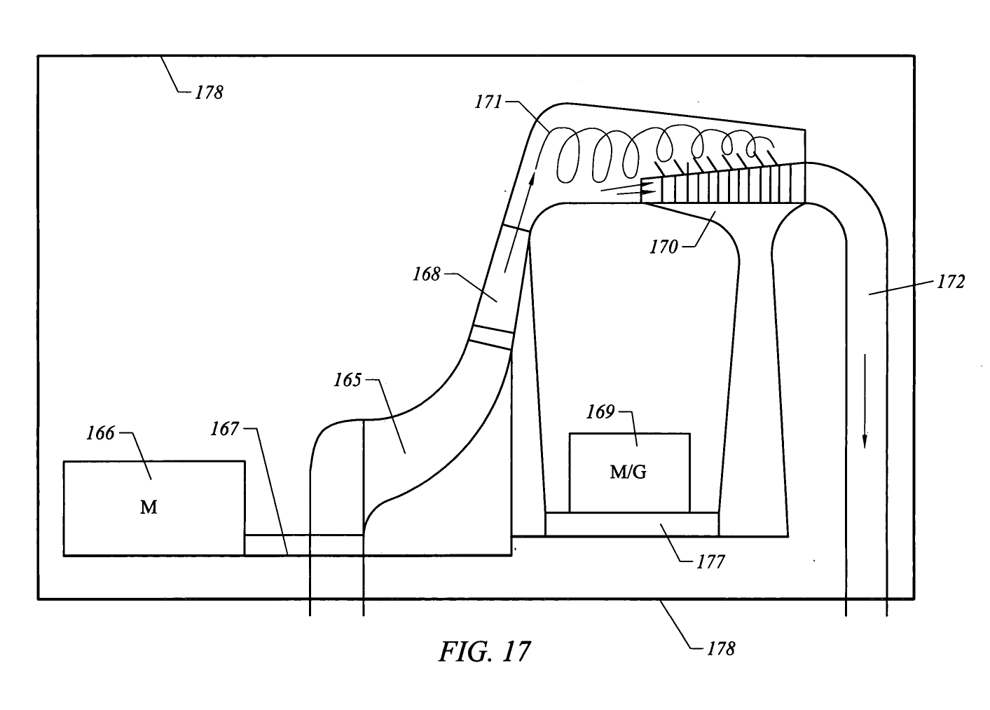

In the embodiments of FIGS. 16 and 17, an axial compressor 161 and a centrifugal compressor 161.1 are coupled and driven at least in part by a motor generator 162, having a common shaft 164, which also connects to an axial gas turbine 163. A high pressure chamber 178 contains a group of high pressure compressors and turbines shown in the enlarged view of FIG. 17. A high pressure centrifugal compressor 165 is driven by an electric motor 166 by interconnecting shaft 167. A final ultra high pressure centrifugal compressor 168 rotates counter to the high pressure centrifugal compressor 165 and is driven by a motor generator 169 and/or a gas turbine 170 through the common shaft 177.

The gas turbine 170 is configured with the annular combustion chamber 171, into which compressed air from the staged high pressure compressors is delivered with a toroidal swirl for complete mixing and combustion. By measured injection of water, the combustion chamber and expansion in the turbine is isothermal with staged entry of the motive gases by the window features as previously described with reference to FIGS. 11 and 12.

The torroidal rotation of the air and fuel around the gas turbine 170 produces the maximum mixing and complete combustion even for heavy, inferior fuels.

From the high pressure chamber 178, an exhaust pipe 172 conveys the medium pressure motive gases to a medium pressure combustion chamber 173.

In the medium pressure combustion chamber 173, the motive gases are introduced with a torroidal swirl where fuel may be added through staged injectors 179 for the isothermal gas turbine 163 before final expansion through an adiabatic power turbine 74 and exit through a discharge nozzle or conduit 175.

In a preferred configuration, the power turbine 174 drives an electric generator 176.

As diagramatically illustrated in FIG. 18, the super pressure Carnot cycle shows isothermal compression from phase points 1-2, which is produced in the axial and centrifugal compressors 161 and 161.1. High pressure adiabatic compression is indicated by phase points 2-3, produced by counter rotating centrifugal compressors 165 and 168 in the pressurized chamber 178.

Isothermal ultra high combustion and expansion indicated by phase points 4-5 is produced in the isothermal combustion chamber 171 and isothermal gas turbine 170.

Isothermal medium combustion and expansion with torroidal swirl is indicated by phase points 5-6 and produced in the combustion chamber 173 and gas turbine 163.

Final adiabatic expansion indicated by phase points 6-7 is produced in power turbine 174.

While, in the foregoing, embodiments of the present invention have been set forth in considerable detail for the purposes of making a complete disclosure of the invention, it may be apparent to those of skill in the art that numerous changes may be made in such detail without departing from the spirit and principles of the invention.

1. A turbo rocket engine comprising:
a housing having an air intake:
an air compressor communicating with the air intake, the air compressor having a cooling system, wherein air is compressed at least in part by isothermal compression; and
a combustion and expansion chamber having a staged combustion system, wherein fuel is combusted and expanded at least in part by isothermal combustion and expansion.

2. The turbo rocket engine of claim 1 wherein the housing has a discharge orifice and an air passage from the air intake to the discharge orifice that bypasses the compressor.

3. The turbo rocket engine of claim 2 wherein the compressor has a centrifugal compressor rotor with blades, wherein the rotor is rotated by air that passes through the blades, wherein the blades are hollow and at least a part of the air from the air intake passes into the hollow blades and is compressed by rotation of the rotor and cooled by passage of air through the blades.

4. The turbo rocket engine of claim 3 wherein the air compressor has hollow struts and a central axial compressor unit, wherein the centrifugal compressor rotor delivers compressed air to the axial compressor unit through the hollow struts.

5. The turbo rocket engine of claim 4 wherein the centrifugal compressor rotor has an extended hub and the axial compressor unit has outwardly directed compressor blades mounted on the extended hub and an air turbine rotor with a core and inwardly directed compressor blades mounted on the core and outer fan-like blades extending into the air bypass passage wherein the outwardly directed compressor blades on the rotor hub rotate counter to the inwardly directed blades on flow of air through the bypass passage.

6. The turbo rocket engine of claim 5 wherein the axial compressor unit is connected to a combustion chamber and to a conical expansion nozzle, wherein at least a part of the conical expansion nozzle has a series of peripheral windows with fuel injectors, wherein compressed air streaming through the windows mixes with fuel for staged combustion and isothermal expansion in that part of the expansion nozzle.

7. The turbo rocket engine of claim 6 wherein the conical expansion nozzle has an expanding part without windows wherein expansion of combusting gases is adiabatic.

8. The turbo rocket engine of claim 7 wherein the conical expansion nozzle discharges combusted gases into the air flow of the bypass passage before discharge through the discharge orifice.

9. The turbo rocket engine of claim 8 wherein the conical expansion nozzle has an open end at the combustion chamber with a fuel injector nozzle.

10. The turbo rocket engine of claim 9 wherein the combustion chamber has a control valve that releases gases in the combustion chamber directly into the bypass passage.

11. The turbo rocket engine of claim 10 including a gas turbine connected in the conical expansion nozzle connected to the centrifugal compressor rotor.

12. The turbot rocket engine of claim 11 further comprising liquid oxygen injector near the air intake and fuel injectors in the by-pass passage near the discharge orifice.

13. The turbo rocket engine of claim 12 having a second stage centrifugal compressor receiving compressed air from the axial compressor unit and delivering super compressed air to the combustion chamber.

14. A cryogenic rocket engine comprising:
a housing having an internal cryogenic oxygen compartment;
a liquid oxygen injector that injects liquid oxygen into the cryogenic oxygen compartment, wherein a cryogenic gaseous oxygen is contained;
a core nozzle unit in the cryogenic oxygen compartment wherein a plenum is formed around the core nozzle unit, the core nozzle unit having a lead venturi nozzle with a fuel injector and a series of multiple conical venturi nozzles of increasing size with windows between nozzles and accompanying staged fuel injectors that provide in part isothermal combustion and expansion, the core nozzle unit having a final ejection nozzle with walls cooled by cryogenic oxygen in the plenum of the cryogenic oxygen compartment.

15. A Carnot cycle engine comprising:
a housing having an air intake and a combustion gas discharge;
an air compression system communicating with the air intake; and
a multi-stage, isothermal combustion system having an expanding nozzle with a first end having a central fuel injector and a series of windows on at least a part of the nozzle near the first end and a second end with an expansion part and a discharge orifice, wherein the combustion system includes an air plenum around the nozzle at the part of the nozzle having the windows and fuel injectors at the windows, wherein compressed air passes from the air compression system to the air plenum and through the windows to mix with fuel for staged isothermal combustion and expansion.

16. The Carnot cycle engine of claim 15 wherein the air compression system includes a variable intake part for ram air compression on propulsion of the engine and liquid oxygen injectors near the air intake for supplementing air at high altitudes and operating the engine as a rocket when the variable intake port is closed.

17. The Carnot cycle engine of claim 15 wherein the air compression system includes an air compressor having a compressed air cooling system.

18. The Carnot cycle engine of claim 17 wherein the compressed air cooling system comprises a by-pass air passage from the air intake to the combustion gas discharge wherein the air compressor has a rotor with hollow centrifugal compression blades and air flow in the by-pass air passage rotates the rotor and cools the compressing air in the blades.

19. The Carnot cycle engine of claim 15 wherein the multi-stage combustion system includes a gas turbine in the expanding nozzle.

20. The Carnot cycle engine of claim 19 wherein the gas turbine is connected to a power generator.
